(19) United States
(12) Patent Application Publication
(10) Pub. No.: US 2026/0135247 A1
(43) Pub. Date: May 14, 2026

(54) SECONDARY BATTERY AND MANUFACTURING METHOD THEREOF

(71) Applicant: SK On Co., Ltd., Seoul (KR)

(72) Inventors: Myeong Seon KWON, Daejeon (KR); Geum Ui NOH, Daejeon (KR); Jang Hyeon MUN, Daejeon (KR); Seong Hwan LEE, Daejeon (KR)

(21) Appl. No.: 19/386,259

(22) Filed: Nov. 12, 2025

(30) Foreign Application Priority Data
Nov. 12, 2024 (KR) 10-2024-0159947

(51) Int. Cl. H01M 50/367; H01M 50/105; H01M 50/121; H01M 50/184

(52) U.S. Cl. CPC H01M 50/367; H01M 50/105; H01M 50/121; H01M 50/184

(57) ABSTRACT

The present disclosure relates to a secondary battery and a method for manufacturing the same. The secondary battery and the method for manufacturing the same include: an electrode assembly; a positive electrode tab; a negative electrode tab; a pouch including an adhesive portion formed by bonding a first portion and a second portion to each other so as to define an accommodation space therein for accommodating the electrode assembly, and to seal the accommodation space while exposing the positive electrode tab and the negative electrode tab to the outside; and a venting member disposed between the first portion and the second portion, the venting member being configured to open at least a part of the adhesive portion to communicate the accommodation space with the outside of the pouch.

### CROSS-REFERENCE TO RELATED PATENT APPLICATION

The present application claims priority under 35 U.S.C. § 119(a) to Korean patent application number 10-2024-0159947 filed on November 12, 2024, in the Korean Intellectual Property Office, the entire disclosure of which is incorporated by reference herein.

### BACKGROUND OF THE INVENTION

### 1. Field

The present disclosure relates to a secondary battery and a method for manufacturing the same, and more particularly, to a secondary battery configured to discharge gas inside a pouch to a predetermined position of the pouch, and a method for manufacturing the same.

### 2. Description of the Related Art

The secondary battery is configured such that a case surrounds an electrode assembly including a positive electrode plate, a negative electrode plate, and a separator, and is formed as a pouch-type secondary battery or a prismatic secondary battery depending on the type of the case.

In the pouch-type secondary battery, the temperature inside the pouch increases during charging or discharging, and as the temperature inside the pouch increases, the pressure inside the pouch increases due to gas generated by vaporization of the electrolyte.

At this time, when the temperature inside the pouch rapidly increases, heat is generated by a chemical reaction between the electrolyte and the electrodes, and when a relatively large amount of heat is generated, the secondary battery may undergo thermal runaway.

In order to solve such a problem, a pouch having a gas outlet formed therein to discharge the gas accommodated inside the pouch to the outside of the pouch has been developed. However, in the conventional pouch, the position at which the gas outlet is formed is not specified. Therefore, when a plurality of secondary batteries are disposed adjacent to each other, the gas discharged from the gas outlet formed in any one of the secondary batteries may be ejected toward an adjacent secondary battery.

As such, when gas having a high temperature is ejected toward an adjacent secondary battery, the secondary battery exposed to the gas may experience a temperature increase and undergo thermal runaway, and as a result, heat may propagate among the plurality of adjacent secondary batteries, causing a plurality of secondary batteries to undergo thermal runaway.

Accordingly, it is necessary to develop a secondary battery and a method for manufacturing the same, which include a pouch capable of specifying the position of the gas outlet so that the discharge direction of the gas can be controlled.

### SUMMARY OF THE INVENTION

An object of the present disclosure is to provide a secondary battery in which the position of formation of a gas outlet can be specified.

Another object of the present disclosure is to provide a method for manufacturing a secondary battery in which the position of formation of a gas outlet can be specified.

The secondary battery and the method for manufacturing the same according to the present disclosure can be widely used in the green technology field utilizing batteries, such as electric vehicles. In addition, the secondary battery and the method for manufacturing the same according to the present disclosure can be applied to environmentally friendly electric vehicles and hybrid vehicles for preventing climate change by suppressing air pollution and greenhouse gas emissions.

As a technical means for solving the above-described technical problems, a secondary battery according to one embodiment of the present disclosure includes: an electrode assembly in which a plurality of positive electrode plates and a plurality of negative electrode plates are alternately stacked with a separator interposed therebetween; a positive electrode tab electrically connected to the plurality of positive electrode plates; a negative electrode tab electrically connected to the plurality of negative electrode plates; a pouch including an adhesive portion formed by bonding a first portion and a second portion to each other so as to define an accommodation space therein for accommodating the electrode assembly, and to seal the accommodation space while exposing the positive electrode tab and the negative electrode tab to the outside; and a venting member disposed between the first portion and the second portion, wherein the venting member can open at least a part of the adhesive portion to communicate the accommodation space with the outside of the pouch when a temperature inside the accommodation space becomes a predetermined temperature or higher and a pressure of the accommodation space increases.

In addition, the venting member may include a body portion provided in a plate shape extending in a longitudinal direction, and a flow path portion which expands when a fluid is introduced therein and forms a flow path communicating one end and the other end of the body portion in the longitudinal direction, wherein one end of the flow path portion in the longitudinal direction may be exposed to the accommodation space, and the other end of the flow path portion in the longitudinal direction may be disposed at a position spaced apart by a predetermined distance from an outer peripheral edge of the adhesive portion.

In addition, a cross-sectional area of the flow path perpendicular to the longitudinal direction may decrease or remain the same from one end of the flow path portion in the longitudinal direction toward the other end of the flow path portion in the longitudinal direction.

In addition, the body portion may be formed of a heat-shrinkable material whose volume decreases when a temperature becomes the predetermined temperature or higher.

In addition, a width of the venting member perpendicular to the longitudinal direction may decrease or remain the same from one end of the venting member in the longitudinal direction toward the other end of the venting member in the longitudinal direction.

In addition, the body portion may be formed of Mylar.

In addition, the venting member may further include an extension portion formed in a tubular shape having a passage penetrating the inside thereof along the longitudinal direction, one end of which is coupled to the flow path portion to communicate the accommodation space with the flow path portion.

In addition, a cross-sectional area of the passage perpendicular to the longitudinal direction may increase or remain the same from one end of the passage toward the other end of the passage.

As a technical means for solving the above-described technical problems, a method for manufacturing a secondary battery according to one embodiment of the present disclosure includes: a preparation step of preparing an electrode assembly electrically connected to a positive electrode tab and a negative electrode tab; an accommodation step of accommodating the electrode assembly in an accommodation space formed inside a pouch; a placement step of disposing a venting member between a first portion and a second portion of the pouch; and an adhesion step of bonding the first portion and the second portion to form an adhesive portion so as to seal the accommodation space while exposing the positive electrode tab and the negative electrode tab to the outside, wherein the venting member can open at least a part of the adhesive portion to communicate the accommodation space with the outside of the pouch when a temperature inside the accommodation space becomes a predetermined temperature or higher and a pressure of the accommodation space increases.

In addition, the venting member may include a body portion formed in a plate shape extending in a longitudinal direction, and a flow path portion which expands when a fluid is introduced therein and forms a flow path communicating one end and the other end of the body portion in the longitudinal direction, wherein one end of the flow path portion in the longitudinal direction may be exposed to the accommodation space, and the other end of the flow path portion in the longitudinal direction may be disposed at a position spaced apart by a predetermined distance from an outer peripheral edge of the adhesive portion.

In addition, a cross-sectional area of the flow path perpendicular to the longitudinal direction may decrease or remain the same from one end of the flow path portion in the longitudinal direction toward the other end of the flow path portion in the longitudinal direction.

In addition, the body portion may be formed of a heat-shrinkable material whose volume decreases when a temperature becomes the predetermined temperature or higher.

In addition, the venting member may further include an extension portion formed in a tubular shape having a passage penetrating the inside thereof along the longitudinal direction, one end of which is coupled to the flow path portion to communicate the accommodation space with the flow path portion.

In addition, the body portion may be formed by bonding two film-shaped materials to each other with an adhesive.

In addition, the adhesive may include at least one of an acrylic-based material and a silicone-based material.

Specific details of other embodiments for solving the above-described problems are included in the description of the invention and the drawings.

According to the means for solving the problems of the present disclosure described above, the secondary battery according to the present disclosure provides an effect in which the position of formation of a gas outlet can be specified by the venting member.

In addition, when the temperature inside the pouch becomes a predetermined temperature or higher, an effect is provided in which the gas outlet can be easily formed.

Furthermore, the method for manufacturing a secondary battery according to the present disclosure provides an effect in which a secondary battery capable of specifying the position of formation of a gas outlet by the venting member can be manufactured.

### BRIEF DESCRIPTION OF THE DRAWINGS

FIG. 1 is an exploded perspective view of a secondary battery according to one embodiment of the present disclosure.

FIG. 2 is a view illustrating the secondary battery.

FIG. 3 is a view illustrating a venting member.

FIG. 4 is a view illustrating the venting member in which a flow path is formed.

FIG. 5 is a view illustrating a film-shaped material forming a body portion.

FIG. 6 is an enlarged view of part A of FIG. 1, showing a state in which an adhesive portion is opened by gas moving through the flow path formed in the venting member.

FIG. 7 is an enlarged view of part A of FIG. 1, showing a state in which an adhesive portion is opened by gas moving through the flow path formed in the venting member formed of a heat-shrinkable material according to one example.

FIG. 8 is an enlarged view of part A of FIG. 1, showing a state in which an adhesive portion is opened by gas moving through the flow path formed in the venting member formed of a heat-shrinkable material according to another example.

FIG. 9 is an enlarged view of part A of FIG. 1, showing the venting member including an extension portion.

FIG. 10 is a flowchart illustrating a method for manufacturing a secondary battery according to one embodiment of the present disclosure.

### DETAILED DESCRIPTION

Hereinafter, embodiments of the present application will be described in detail with reference to the accompanying drawings so that those skilled in the art to which the present application pertains can easily carry out the invention. However, the present application may be embodied in various different forms and is not limited to the embodiments described herein. In the drawings, parts irrelevant to the description are omitted for clarity, and like reference numerals denote like elements throughout the specification.

In the entire specification, when a part is referred to as being “connected” to another part, it includes not only cases where they are “directly connected” but also cases where they are “electrically connected” with another element interposed therebetween.

In the entire specification, when a member is described as being “on” another member, it includes not only cases where the member is in contact with the other member but also cases where another member exists between the two members.

In the entire specification, when a part is described as “including” a component, unless otherwise stated, it does not exclude other components but may further include other components.

In the entire specification, degree terms such as “about” and “substantially” are used to indicate values that include manufacturing and material tolerances inherent in the specified meaning or values close thereto, and are used to prevent an unscrupulous infringer from unfairly taking advantage of precise or absolute numerical disclosures provided for the purpose of understanding the invention.

In the entire specification, the degree expressions “the step of~” or “a step of~” do not mean “a step for~.”

Hereinafter, preferred embodiments of the present disclosure will be described in detail with reference to the accompanying drawings and the following description. However, the present disclosure is not limited to the embodiments described herein and may be embodied in other forms. The same reference numerals throughout the specification refer to the same elements.

Hereinafter, the configuration of a secondary battery according to one embodiment of the present disclosure will be described.

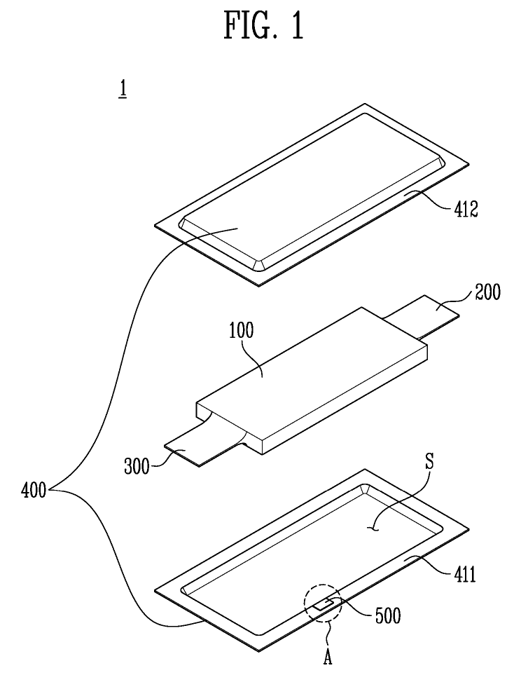

FIG. 1 is an exploded perspective view of a secondary battery according to one embodiment of the present disclosure.

Referring to FIG. 1, the secondary battery 1 includes an electrode assembly 100, a positive electrode tab 200, a negative electrode tab 300, a pouch 400, and a venting member 500.

First, the electrode assembly 100 will be described.

The electrode assembly 100 may be formed by alternately stacking a plurality of positive electrode plates and a plurality of negative electrode plates with a separator interposed therebetween, and each of the positive electrode plate and the negative electrode plate is formed with a non-coated portion extending therefrom.

The positive electrode plate may function as a positive electrode and may be formed by applying a first electrode active material such as a transition metal oxide onto a first electrode current collector formed of a metal foil such as aluminum.

The positive electrode plate includes a first electrode non-coated portion, which is a region where the first electrode active material is not applied, and the first electrode non-coated portion may serve as a current flow path between the positive electrode plate and the outside, and may also form a positive electrode tab 200 described later.

The negative electrode plate may function as a negative electrode and may be formed by applying a second electrode active material such as graphite or carbon onto a second electrode current collector formed of a metal foil such as copper or nickel.

The negative electrode plate includes a second electrode non-coated portion, which is a region where the second electrode active material is not applied, and the second electrode non-coated portion may serve as a current flow path between the negative electrode plate and the outside, and may also form a negative electrode tab 300 described later.

The separator is positioned between the positive electrode plate and the negative electrode plate to prevent a short circuit and to allow the movement of lithium ions. The separator may be made of polyethylene, polypropylene, or a composite film of polyethylene and polypropylene.

Next, the positive electrode tab 200 will be described.

Referring to FIG. 1, the positive electrode tab 200 may be electrically connected to the plurality of positive electrode plates.

The positive electrode tab 200 may be formed as a separate member coupled to the first electrode non-coated portion, or may be formed by the first electrode non-coated portion as described above.

Next, the negative electrode tab 300 will be described.

Referring to FIG. 1, the negative electrode tab 300 may be electrically connected to the plurality of negative electrode plates.

The negative electrode tab 300 may be formed as a separate member coupled to the second electrode non-coated portion, or may be formed by the second electrode non-coated portion as described above.

Next, the pouch 400 will be described.

The pouch 400 may serve as an exterior member that accommodates the electrode assembly 100 therein.

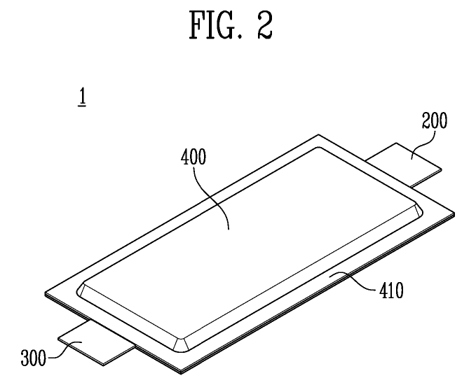

FIG. 2 is a view illustrating the secondary battery.

Specifically, as shown in FIG. 1, the pouch 400 may have an accommodation space S formed therein to accommodate the electrode assembly 100, and, as shown in FIG. 2, may include an adhesive portion 410 formed by bonding a predetermined first portion 411 and a predetermined second portion 412 to each other so as to seal the accommodation space S while exposing the positive electrode tab 200 and the negative electrode tab 300 to the outside.

As such, when the first portion 411 and the second portion 412 are bonded in a state in which the electrode assembly 100 is accommodated in the accommodation space S, the accommodation space S may be sealed.

Next, the venting member 500 will be described.

As shown in FIG. 1, the venting member 500 may be disposed between the first portion 411 and the second portion 412, and at least one or more venting members 500 may be disposed between the first portion 411 and the second portion 412.

The venting member 500 may perform a function of opening at least a part of the adhesive portion 410 to communicate the accommodation space S with the outside of the pouch 400 when the temperature of the accommodation space S becomes a predetermined temperature or higher and the pressure of the accommodation space S increases.

That is, when the temperature of the accommodation space S increases, the venting member 500 may perform a function of guiding the discharge of gas (hereinafter referred to as “gas”) accommodated in the accommodation space S to be discharged only through the position of the adhesive portion 410 where the venting member 500 is disposed.

At this time, the predetermined temperature may be a temperature that causes thermal runaway of the secondary battery and may be a temperature in a range of 126°C to 150°C.

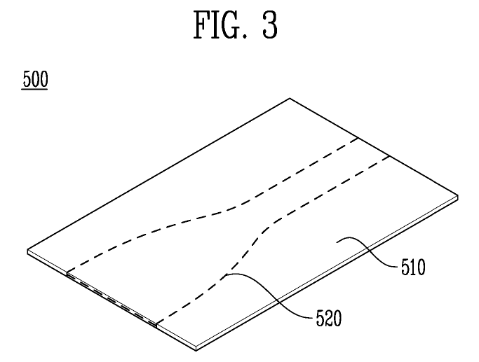

FIG. 3 is a view illustrating a venting member.

As shown in FIG. 3, the venting member 500 includes a body portion 510 and a flow path portion 520.

The body portion 510 may be formed in a plate shape extending in a longitudinal direction and may be formed of various materials.

For example, the body portion 510 may be formed of a heat-shrinkable material whose volume decreases when a temperature becomes a predetermined temperature or higher.

Specifically, the body portion 510 may be formed of Mylar. Generally, the temperature that causes thermal runaway of a secondary battery is in the range of 126°C to 150°C, and since Mylar has a heat-shrinkable temperature in the range of 126°C to 150°C, when the body portion 510 is formed of Mylar, the body portion 510 contracts when the temperature of the secondary battery reaches the temperature that causes thermal runaway.

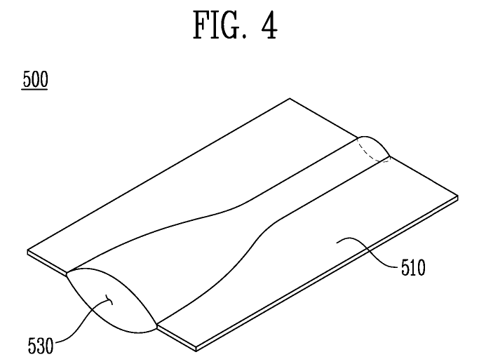

FIG. 4 is a view illustrating the venting member in which a flow path is formed.

As shown in FIG. 4, the flow path portion 520 may expand when a fluid is introduced therein, thereby forming a flow path 530 that communicates one end and the other end of the body portion 510 in the longitudinal direction.

The shape of the flow path 530 is not limited; however, as shown in FIG. 4, it is preferable that the cross-sectional area of the flow path 530 perpendicular to the longitudinal direction decreases or remains the same from one end of the flow path portion 520 in the longitudinal direction toward the other end of the flow path portion 520 in the longitudinal direction.

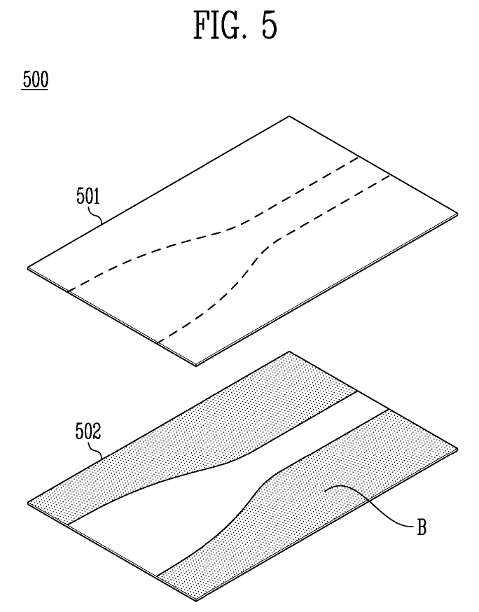

FIG. 5 is a view illustrating a film-shaped material forming a body portion.

Meanwhile, as shown in FIG. 5, the body portion 510 may be formed by bonding two film-shaped materials 501 and 502.

Specifically, the body portion 510 may be formed by applying an adhesive to a portion B, which is a region other than the portion where the flow path portion 520 of the two film-shaped materials 501 and 502 is to be formed, and then bonding the two film-shaped materials 501 and 502 to each other.

At this time, the adhesive for bonding the two film-shaped materials 501 and 502 may include at least one of an acrylic-based material and a silicone-based material; however, the composition of the adhesive is not limited thereto.

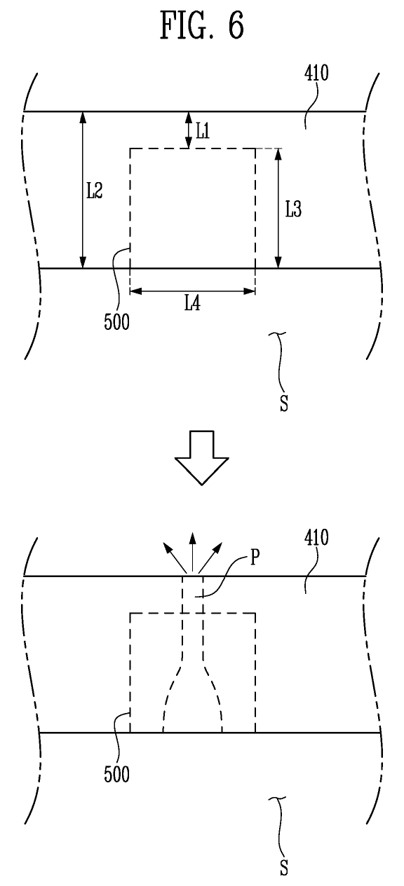

FIG. 6 is an enlarged view of part A of FIG. 1, showing a state in which an adhesive portion is opened by gas moving through the flow path formed in the venting member.

As shown in FIG. 6, in the venting member 500 formed as described above, one end of the flow path portion 520 in the longitudinal direction may be exposed to the accommodation space S, and the other end of the flow path portion 520 in the longitudinal direction may be disposed at a position spaced apart by a predetermined distance L1 from the outer peripheral edge of the adhesive portion 410.

At this time, a shortest length L2 of the adhesive portion 410 from the outer peripheral edge of the adhesive portion 410 to the accommodation space S may be 1.5 cm or more and 4.5 cm or less, the predetermined distance L1 may be 0.3 cm or more and 0.5 cm or less, a longitudinal length L3 of the venting member 500 may be 1 cm or more and 4 cm or less, and a width L4 in a width direction may be 0.5 cm or more and 3 cm or less. However, the configuration of the adhesive portion length L2, the predetermined distance L1, the longitudinal length L3 of the venting member 500, and the width L4 is not limited thereto.

As shown in FIG. 6, when the temperature of the accommodation space S becomes a predetermined temperature or higher and the pressure of the accommodation space S increases, gas is introduced into the inside of the flow path portion 520 of the venting member 500, thereby forming the flow path 530, and the gas moving through the flow path 530 presses at least a part P of the adhesive portion 410 adjacent to the flow path 530, thereby opening at least a part P of the adhesive portion 410.

At this time, when the flow path 530 is formed such that the cross-sectional area of the flow path 530 perpendicular to the longitudinal direction decreases or remains the same from one end of the flow path portion 520 in the longitudinal direction toward the other end, according to Bernoulli’s principle, the force with which the gas moving through the flow path 530 presses at least a part P of the adhesive portion 410 increases, so that at least a part P of the adhesive portion 410 can be easily opened.

Meanwhile, the venting member 500 may be formed such that at least a part P of the adhesive portion 410 can be opened more easily.

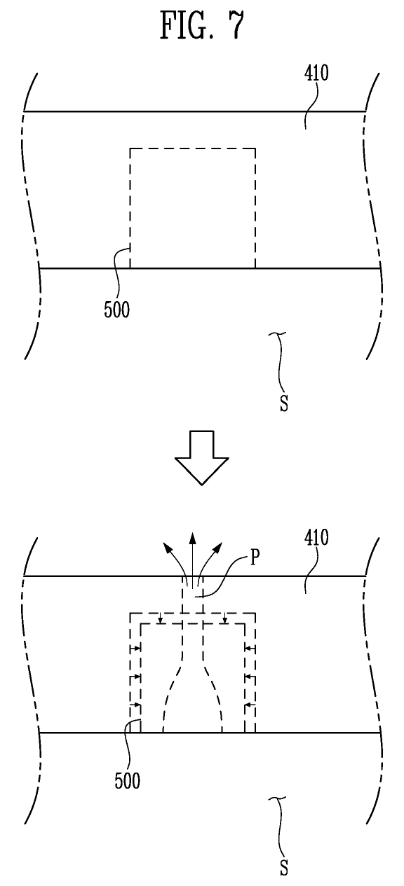

FIG. 7 is an enlarged view of part A of FIG. 1, showing a state in which an adhesive portion is opened by gas moving through the flow path formed in the venting member formed of a heat-shrinkable material according to one example.

For example, referring to FIG. 7, the venting member 500 may be formed of a heat-shrinkable material and disposed on the adhesive portion 410, and may allow gas to move through the flow path 530.

At this time, since the temperature of the accommodation space S is a predetermined temperature or higher, and the temperature of the gas moving through the flow path 530 is also a predetermined temperature or higher, the venting member 500 receives heat from the accommodation space S and the flow path 530 and contracts, thereby reducing its longitudinal length and width.

As the venting member 500 contracts, as shown in FIG. 7, a gap is generated between the adhesive portion 410 and the venting member 500 adjacent to the other end of the venting member 500 in the longitudinal direction, and gaps are also generated between the adhesive portion 410 and the venting member 500 adjacent to both ends of the venting member 500 in the width direction.

Accordingly, the adhesive force of the adhesive portion 410 adjacent to the venting member 500 is weakened, and at least a part P of the adhesive portion 410 adjacent to the venting member 500 can be opened more easily by the pressure of the gas moving through the flow path 530 of the venting member 500.

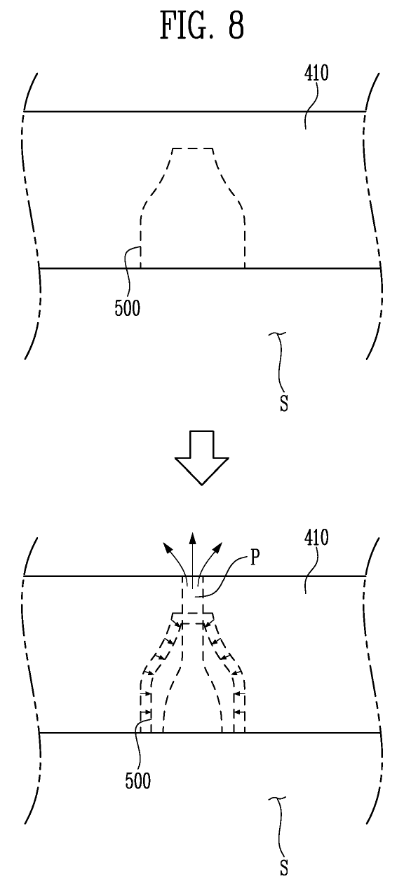

FIG. 8 is an enlarged view of part A of FIG. 1, showing a state in which an adhesive portion is opened by gas moving through the flow path formed in the venting member formed of a heat-shrinkable material according to another example.

For another example, referring to FIG. 8, the venting member 500 may be formed of a heat-shrinkable material and disposed on the adhesive portion 410. The venting member 500 may be formed such that a width perpendicular to the longitudinal direction decreases or remains the same from one end of the venting member 500 in the longitudinal direction toward the other end, and may allow gas to move through the flow path 530.

At this time, since the temperature of the accommodation space S is a predetermined temperature or higher, and the temperature of the gas moving through the flow path 530 is also a predetermined temperature or higher, the venting member 500 receives heat from the accommodation space S and the flow path 530 and contracts, thereby reducing its longitudinal length and width.

As the venting member 500 contracts, as shown in FIG. 8, a gap is generated between the adhesive portion 410 and the venting member 500 adjacent to the other end of the venting member 500 in the longitudinal direction, and gaps are also generated between the adhesive portion 410 and the venting member 500 adjacent to both ends of the venting member 500 in the width direction.

Meanwhile, since the width of the venting member 500 perpendicular to the longitudinal direction decreases or remains the same from one end of the venting member 500 in the longitudinal direction toward the other end, the gap generated between the adhesive portion 410 and the venting member 500 adjacent to the other end of the venting member 500 in the longitudinal direction becomes closer to at least a part P of the adhesive portion 410.

Accordingly, the adhesive force of the adhesive portion 410 adjacent to the venting member 500, particularly the adhesive force of the adhesive portion 410 adjacent to at least a part P of the adhesive portion 410, is weakened, and at least a part P of the adhesive portion 410 adjacent to the venting member 500 can be opened more easily by the pressure of the gas moving through the flow path 530 of the venting member 500.

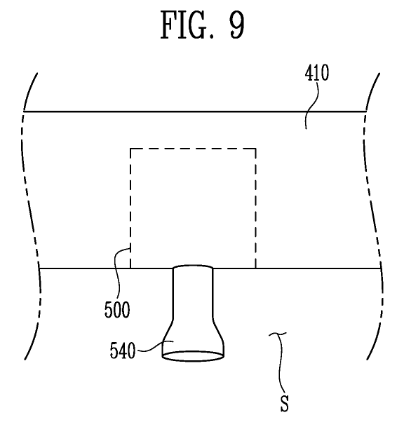

FIG. 9 is an enlarged view of part A of FIG. 1, showing the venting member including an extension portion.

For yet another example, referring to FIG. 9, the venting member 500 may be formed in a tubular shape having a passage penetrating the inside thereof along the longitudinal direction, and may further include an extension portion 540, one end of which is coupled to the flow path portion 520 to communicate the accommodation space S with the flow path portion 520.

When the venting member 500 includes the extension portion 540 as described above, gas can be more easily introduced into the flow path portion 520 through the passage of the extension portion 540, so that at least a part P of the adhesive portion 410 can be opened more easily.

The extension portion 540 merely needs to have a passage formed therein along the longitudinal direction, and its shape is not particularly limited.

For example, the extension portion 540 may be formed such that the cross-sectional area of the passage perpendicular to the longitudinal direction increases or remains the same from one end of the passage toward the other end. That is, the passage may be formed so that, according to Bernoulli’s principle, the gas moving toward the flow path portion 520 has greater pressure as it approaches the flow path portion 520.

Hereinafter, a method for manufacturing a secondary battery according to one embodiment of the present disclosure will be described.

The secondary battery manufactured by the method for manufacturing a secondary battery according to one embodiment of the present disclosure may be the same as the secondary battery according to one embodiment of the present disclosure.

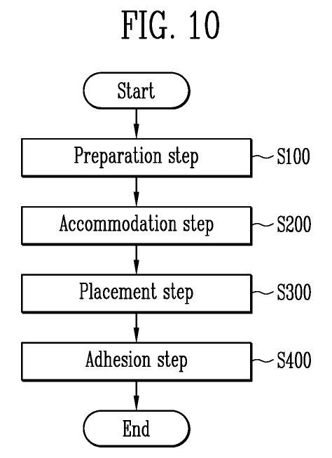

FIG. 10 is a flowchart illustrating a method for manufacturing a secondary battery according to one embodiment of the present disclosure.

Referring to FIG. 10, the method for manufacturing the secondary battery includes a preparation step S100, an accommodation step S200, a placement step S300, and an adhesion step S400.

First, the preparation step S100 will be described.

The preparation step S100 is a step of preparing an electrode assembly 100 electrically connected to a positive electrode tab 200 and a negative electrode tab 300.

Since the specific configurations of the electrode assembly 100, the positive electrode tab 200, and the negative electrode tab 300 are the same as those of the electrode assembly 100, the positive electrode tab 200, and the negative electrode tab 300 of the aforementioned secondary battery 1, detailed descriptions thereof will be omitted hereinafter.

Next, the accommodation step S200 will be described.

The accommodation step S200 is a step of accommodating the electrode assembly 100 in an accommodation space S formed inside the pouch 400.

Since the specific configuration of the pouch 400 is the same as that of the pouch 400 of the aforementioned secondary battery 1, detailed descriptions thereof will be omitted hereinafter.

Next, the placement step S300 will be described.

The placement step S300 is a step of disposing the venting member 500 between a predetermined first portion 411 of the pouch 400 and a predetermined second portion 412 of the pouch 400.

At this time, the venting member 500 may be configured to open at least a part of the adhesive portion 410 to communicate the accommodation space S with the outside of the pouch 400 when the temperature of the accommodation space S becomes a predetermined temperature or higher and the pressure of the accommodation space S increases.

Since the specific configuration of the venting member 500 and the specific arrangement of the venting member 500 disposed on the adhesive portion 410 are the same as those of the venting member 500 and the venting member 500 disposed on the adhesive portion 410 of the aforementioned secondary battery 1, detailed descriptions thereof will be omitted hereinafter.

Next, the adhesion step S400 will be described.

The adhesion step S400 is a step of bonding the first portion 411 of the pouch 400 and the second portion 412 of the pouch 400 to form the adhesive portion 410 so as to seal the accommodation space S while exposing the positive electrode tab 200 and the negative electrode tab 300 to the outside.

Since the specific configurations of the first portion 411, the second portion 412, and the adhesive portion 410 of the pouch 400 are the same as those of the first portion 411, the second portion 412, and the adhesive portion 410 of the pouch 400 of the aforementioned secondary battery 1, detailed descriptions thereof will be omitted hereinafter.

Hereinafter, the operation and effects of the secondary battery according to one embodiment of the present disclosure will be described.

After the electrode assembly 100 is accommodated in the accommodation space S of the pouch 400, the first portion 411 and the second portion 412 of the pouch 400 are bonded to form the adhesive portion 410, thereby sealing the accommodation space S.

At this time, the venting member 500 is disposed at a predetermined position between the first portion 411 and the second portion 412.

When the temperature of the accommodation space S increases, the venting member 500 allows the gas accommodated in the accommodation space S to move through the flow path 530 formed therein, and the gas moved through the flow path 530 opens at least a part P of the adhesive portion 410 to communicate the accommodation space S with the outside of the pouch 400.

Meanwhile, the venting member 500 may be formed of a heat-shrinkable material, and when the venting member 500 is formed of a heat-shrinkable material, the venting member 500 is heated and contracted as the temperature of the accommodation space S increases.

Accordingly, a gap is generated between the venting member 500 and the adhesive portion 410, and the adhesive force of the adhesive portion 410 adjacent to the venting member 500 is weakened, so that at least a part P of the adhesive portion 410 adjacent to the venting member 500 can be opened more easily.

As described above, the secondary battery according to the present disclosure provides an effect in which the position of formation of a gas outlet can be specified by the venting member.

In addition, an effect is provided in which the gas outlet can be easily formed when the temperature inside the pouch becomes a predetermined temperature or higher.

In addition, the method for manufacturing a secondary battery according to the present disclosure provides an effect in which a secondary battery capable of specifying the position of formation of a gas outlet by the venting member can be manufactured.

The above description of the present disclosure is for illustrative purposes, and it will be understood by those skilled in the art to which the present disclosure pertains that various modifications can be made thereto in other specific forms without changing the technical spirit or essential features of the present disclosure. Therefore, the embodiments described above are to be understood as illustrative in all aspects and not restrictive. For example, each component described as being implemented in a single form may be implemented in a distributed manner, and similarly, components described as being distributed may be implemented in a combined form.

The scope of the present disclosure is defined by the following claims rather than by the foregoing detailed description, and it should be construed that all modifications or variations derived from the meaning, scope, and equivalents of the claims fall within the scope of the present disclosure.

What is claimed is:

1. A secondary battery comprising:
an electrode assembly in which a plurality of positive electrode plates and a plurality of negative electrode plates are alternately stacked with a separator interposed therebetween;
a positive electrode tab electrically connected to the plurality of positive electrode plates;
a negative electrode tab electrically connected to the plurality of negative electrode plates;
a pouch including an adhesive portion formed by bonding a first portion and a second portion to each other so as to define an accommodation space therein for accommodating the electrode assembly, and to seal the accommodation space while exposing the positive electrode tab and the negative electrode tab to the outside; and
a venting member disposed between the first portion and the second portion,
wherein the venting member opens at least a part of the adhesive portion to communicate the accommodation space with the outside of the pouch when a temperature inside the accommodation space becomes a predetermined temperature or higher and a pressure of the accommodation space increases.

2. The secondary battery according to claim 1, wherein the venting member comprises:
a body portion having a plate shape extending in a longitudinal direction; and
a flow path portion including a flow path which expands when a fluid is introduced therein and which communicates one end and the other end of the body portion in the longitudinal direction,
wherein one end of the flow path portion in the longitudinal direction is exposed to the accommodation space, and the other end of the flow path portion in the longitudinal direction is disposed at a position spaced apart by a predetermined distance from an outer peripheral edge of the adhesive portion.

3. The secondary battery according to claim 2, wherein a cross-sectional area of the flow path perpendicular to the longitudinal direction decreases or remains the same from one end of the flow path portion in the longitudinal direction toward the other end of the flow path portion in the longitudinal direction.

4. The secondary battery according to claim 3, wherein the body portion is formed of a heat-shrinkable material whose volume decreases when a temperature becomes the predetermined temperature or higher.

5. The secondary battery according to claim 4, wherein a width in a direction perpendicular to the longitudinal direction of the venting member decreases or remains the same from one end of the venting member in the longitudinal direction toward the other end of the venting member in the longitudinal direction.

6. The secondary battery according to claim 4, wherein the body portion is formed of Mylar.

7. The secondary battery according to claim 2, wherein the venting member further comprises an extension portion formed in a tubular shape having a passage penetrating the inside thereof along the longitudinal direction, one end of which is coupled to the flow path portion to communicate the accommodation space with the flow path portion.

8. The secondary battery according to claim 7, wherein a cross-sectional area of the passage perpendicular to the longitudinal direction increases or remains the same from one end of the passage toward the other end of the passage.

9. A method for manufacturing a secondary battery, comprising:
a preparation step of preparing an electrode assembly electrically connected to a positive electrode tab and a negative electrode tab;
an accommodation step of accommodating the electrode assembly in an accommodation space formed inside a pouch;
a placement step of disposing a venting member between a first portion and a second portion of the pouch; and
an adhesion step of bonding the first portion and the second portion to form an adhesive portion so as to seal the accommodation space while exposing the positive electrode tab and the negative electrode tab to the outside,
wherein the venting member opens at least a part of the adhesive portion to communicate the accommodation space with the outside of the pouch when a temperature inside the accommodation space becomes a predetermined temperature or higher and a pressure of the accommodation space increases.

10. The method for manufacturing a secondary battery according to claim 9, wherein the venting member comprises:
a body portion formed in a plate shape extending in a longitudinal direction; and
a flow path portion which expands when a fluid is introduced therein and forms a flow path communicating one end and the other end of the body portion in the longitudinal direction,
wherein one end of the flow path portion in the longitudinal direction is exposed to the accommodation space, and the other end of the flow path portion in the longitudinal direction is disposed at a position spaced apart by a predetermined distance from an outer peripheral edge of the adhesive portion.

11. The method for manufacturing a secondary battery according to claim 10, wherein a cross-sectional area of the flow path perpendicular to the longitudinal direction decreases or remains the same from one end of the flow path portion in the longitudinal direction toward the other end of the flow path portion in the longitudinal direction.

12. The method for manufacturing a secondary battery according to claim 11, wherein the body portion is formed of a heat-shrinkable material whose volume decreases when a temperature becomes the predetermined temperature or higher.

13. The method for manufacturing a secondary battery according to claim 12, wherein the venting member further comprises an extension portion formed in a tubular shape having a passage penetrating the inside thereof along the longitudinal direction, one end of which is coupled to the flow path portion to communicate the accommodation space with the flow path portion.

14. The method for manufacturing a secondary battery according to claim 10, wherein the body portion is formed by bonding two film-shaped materials to each other with an adhesive.

15. The method for manufacturing a secondary battery according to claim 14, wherein the adhesive comprises at least one of an acrylic-based material and a silicone-based material.
